(19) United States
(12) Patent Application Publication
(10) Pub. No.: US 2004/0113945 A1
(43) Pub. Date: Jun. 17, 2004

(54) Graphical user interface and method for interfacing with a configuration system for highly configurable products

(75) Inventors: Samuel H. Park, Mt. Lake Terrace, WA (US); Keva Michael Moskowitz, Seattle, WA (US); Kevin Earl Meboe, Bellevue, WA (US); Daniel Malcolm Toloudis, Seattle, WA (US)

Correspondence Address: GENERAL NUMBER 00757, BRINKS HOFER GILSON & LIONE, P.O. BOX 10395, CHICAGO, IL, 60611, US

(73) Assignee: Herman Miller, Inc.

(21) Appl. No.: 10/317,814

(22) Filed: Dec. 12, 2002

(51) Int. Cl. G09G 5/00

(52) U.S. Cl. 345/765; 345/848

(57) ABSTRACT

A graphical user interface (“GUI”) and method is disclosed for use with a product specification computer program for specifying complex highly configurable products. The GUI provides for simultaneously displaying, navigating, selecting and assembling of complex objects/products and configuration thereof into a design layout using a multi-pane display. The display provides both two dimensional and three dimensional representations of the design layout as well as product selection and manipulation tools.

### BACKGROUND

The purchase of complex, highly configurable products, such as office furniture products, can be a tedious and time consuming task, given that such products offer so many different options and can be configured, e.g. one product in relationship to/with other products, in so many different ways. Often a consultant, designer or design team must be employed who understands the products, their various numerous options and how to apply them to the needs of the buyer. For small offices, the office administrator may be charged with the task of planning and purchasing such products. In particular with office furniture products, the consultant or planner has to have an understanding of the needs of their client's business operations, a knowledge of interior design and an intimate familiarity with the myriad of products and systems, their options, as well as the multitude of ways they can be configured, available from a given manufacturer(s).

To aid in the planning of office space and the selection and purchase of furniture products, manufacturers of such products, as well as third party software vendors, may provide computer based tools which can be used by consultants or planners, or by the dealers which service them. For example, Z-Axis (also referred to herein as “classic” Z-Axis”), distributed by Herman Miller, Inc., located in Zeeland, Mich. is a furniture/office space configuration tool which allows a user to design an office space using Herman Miller furniture products and selected products from other manufacturers. Classic Z-Axis further allows the user to convert the finished design into an order for the selected products. Unfortunately, classic Z-Axis suffers from crude graphic imaging and a relatively complex user interface which is difficult to learn and operate and which makes designing an office space unnecessarily complex. Third party tools are also available, such as a generic CAD program which can be used for such planning. For example, AutoCAD 2002, manufactured by Autodesk Corporation, located in San Rafael, Calif., is generic industrial computer aided design tool. While AutoCAD is a very powerful design tool, in general, the generic design focus of these types of CAD tools makes them very complex programs to learn and operate for specific tasks such as office space planning. Further these tools lack the specific functionality to aid the user in configuring and purchasing appropriate products, options and accessories to achieve their design goals.

Accordingly, there is a need for a product configuration tool for highly complex/configurable products, such as office furniture products, which provides an intuitive user interface and functionality tailored to the products being configured.

### SUMMARY

The present invention is defined by the following claims, and nothing in this section should be taken as a limitation on those claims. By way of introduction, the preferred embodiments described below relate to a graphical user interface for interfacing a user with a product specification computer program used for generating a design comprising a configuration of a plurality of products. The graphical user interface includes a graphical window for display on a computer display coupled with a computer comprising the computer program, the graphical window comprising first, second, third and fourth portions, each of the first, second, third and fourth portions capable of receiving input from a user via a user input device coupled with the computer and displaying output to the user. Further the first portion comprises a display of a catalog of the plurality of products available for inclusion in the design, the first portion operative to receive a selection by the user of a first product from the catalog for inclusion in the design and further operative to receive a first configuration of the selected first product. The second portion comprises a display of information specific to the selected first product having the first configuration. The third portion is operative to receive an arrangement specified by the user of the selected first product within the design, the selected first product having the first configuration, wherein the arrangement comprises an assembly of the first product with a second product, the second product having been previously arranged and further wherein the third portion comprises a display of a two dimensional plan view of the design comprising the selected, configured and arranged first product. The fourth portion comprises a display of a three dimensional view of the design comprising the selected, configured, and arranged product.

The preferred embodiments further relate to a method for interfacing a user with a product specification computer program used for generating a design, the design comprising a configuration of a plurality of products. In one embodiment, the method includes displaying a window on a computer display coupled with a computer comprising the computer program, the window comprising at least first, second, third and fourth portions, each of the first, second, third and fourth portions capable of receiving input from a user via a user input device coupled with the computer and displaying output to the user. The method further includes displaying in the first portion, a catalog of the plurality of products available for inclusion in the design, receiving in the first portion, a selection by the user of a first product from the catalog for inclusion in the design, receiving in the first portion, a first configuration of the selected first product, displaying in the second portion, information specific to the selected first product having the first configuration, receiving in the third portion, an arrangement specified by the user of the selected first product within the design, the selected first product having the first configuration, wherein the arrangement comprises an assembly of the first product with a second product, the second product having been previously arranged, displaying in the third portion, a two dimensional plan view of the design comprising the selected, configured and arranged first product, and displaying in the fourth portion, a three dimensional view of the design comprising the selected, configured, and arranged product.

Further aspects and advantages of the invention are discussed below in conjunction with the preferred embodiments.

### BRIEF DESCRIPTION OF THE DRAWINGS

FIG. 1 depicts block diagram of a product configuration program according to a first embodiment.

FIG. 2 depicts an exemplary graphical user interface for use with embodiment of FIG. 1.

FIG. 3 depicts an exemplary graphical interface window pane for use with the graphical user interface of FIG. 2 for displaying a product catalog.

FIG. 4 depicts an exemplary graphical interface window pane for use with the graphical user interface of FIG. 2 for displaying an edit function menu.

FIG. 5 depicts an exemplary graphical interface window for use with the graphical user interface of FIG. 2 for selecting a portion of a design.

FIG. 6 depicts an exemplary graphical interface window for use with the graphical user interface of FIG. 2 for displaying a three dimensional view of a selected portion of a design.

FIG. 7 depicts an exemplary graphical interface window for use with the graphical user interface of FIG. 2 for displaying an inventory list of products included in a design.

FIG. 8 depicts an exemplary graphical interface window pane for use with the graphical user interface of FIG. 2 for displaying a three dimensional view of a selected product.

FIG. 9 depicts an exemplary graphical interface window pane for use with the graphical user interface of FIG. 2 for displaying a product attachment interface for a selected product.

FIGS. 10A-10C depicts an exemplary graphical interface window pane for use with the graphical user interface of FIG. 2 for displaying configuring a selected product having multiple components.

FIG. 11 depicts an exemplary graphical interface window pane for use with the graphical user interface of FIG. 2 for displaying a 2 dimensional plan view of a design.

FIG. 12 depicts an exemplary graphical interface window pane for use with the graphical user interface of FIG. 2 for displaying a three dimensional view of a design.

FIG. 13 depicts a flow chart showing exemplary operation of the graphical user interface of FIG. 2.

### DETAILED DESCRIPTION OF THE PRESENTLY PREFERRED EMBODIMENTS

The disclosed embodiments relate to a graphical user interface for a computer program which enables a user to select, configure, arrange and finalize an order for complex highly configurable products, such as office furniture. The graphical user interface permits the user to create and view a design layout representing the products they have selected and office/floor plan layout configurations as they will be arranged in their intended use. Displays are provided which allow the user to view, edit and confirm their design in multiple formats. Further, the interface and computer program provide logic which assists the user in configuring complex products which interact with other products, such as products which attach to other products, to ensure that the correct product is selected, that the desired configuration is available and the necessary components to enable the desired configuration are included in the design and the ultimate purchase order. Additional logic provides functions which simplify the coordination of products and their various options, such as fabric color. Once the design is complete, the interface permits simplified order generation to order the selected products, as well as any required associated products, in the given configurations.

The disclosed embodiments are generally applicable to products which include, but are not limited to, consumer products intended as inventory or for end user consumption as well as industrial products, including consumable and durable goods. Such products further include complex or highly configurable products which have one or more optional features, accessories, parameters, arrangements, configurations, component parts or other characteristics, collectively referred to as options. The customer may specify the inclusion or exclusion of the option, such as whether or not a chair has arms. Further, each option may have one or more choices or values associated with it, such as the material of the optional arms. Such options may be specified by the customer at the time the order is placed or dictated by other factors such as the availability/manufacturability of particular option combinations or other constraints, such as other products or services also being ordered which are intended to be compatible with the complex product. In addition, some options may be included or have pre-set values by default with the customer being allowed to modify or exclude the option if they so choose.

In addition, complex products further include those products which may require additional required and/or optional products in order to function depending on the environment in which those products are to be used and whether or not those products are intended to interact, connect or otherwise be coupled with other products. For example, two products may be purchased for the purpose of connecting/coupling those products, i.e. assembling those two products, together, such as two panels/walls which may be assembled to create part of a cubicle or a keyboard tray which may be assembled to a work surface. In addition to the two panels, additional products may be required to assemble the first panel to the second panel and to finish the unconnected ends of each panel, such as bolts, connectors, end caps, etc. In some product lines, additional items, such as top caps and/or wire management troughs may also be required as additional products.

An exemplary set of complex highly configurable products includes office furniture products such as workstations (panel-based, pole and arm-based, or interconnected free standing products), chairs and file cabinets or other storage products. Office furniture products which share a common design theme, motif or architecture are typically grouped as a product line. An exemplary office furniture product line is the Action Office® Systems product line manufactured by Herman Miller, Inc., located in Zeeland, Mich. Typically such product lines offer a wide variety of furniture products, each of which are offered with a wide array of options including color options and fabric choices. In addition, depending on the configuration of these furniture products, additional supporting products, such as connectors, supports, etc. may also be required.

In one embodiment, products lines are classified into categories based on the products and/or services within that product line, such as “freestanding” which contains such products as tables and freestanding desks, “seating” which contains such products as work/task chairs and guest chairs, and “systems” described in more detail below. Other categories of products lines include “filing and storage” and “accessories.” A “system” is a set/combination of physically connected individual products, such as walls or panels or poles with arms, work surfaces, drawers or pedestals, or cabinets or flipper/overhead storage units plus all of the connector and supporting hardware products to accomplish the physical connection, that make up a workstation.

When ordering furniture products, the customer typically first specifies whether they want to order a system and/or freestanding product and then specifies which product line they wish to order from. In addition, for each system and/or individual piece ordered, the customer must specify all of the various options, required and/or optional, which are available as described above or otherwise alter or confirm/accept default options. Piece-wise ordering refers to procuring individual products/services such as freestanding tables or work/task chairs within particular, or across, product lines. Procuring systems furniture, and in some cases, highly configurable freestanding products, is much more complex than piece-wise ordering since, not only does each product have its own set of options, but the interrelation of one product with another one or more products in the system may affect option choices or may require the further purchase of additional products. For example, the color, surface material, fabric type, leg configuration, etc. option of one product in a system may limit or be limited by the similar option choices of other products in the system. It is common for a typical furniture product line to have millions of product and option combinations. While not physically connected with the products which make up a system, some highly configurable freestanding products also may have options which may be affected by the options of other system or freestanding products, such as color, surface material or fabric type, which are typically chosen to match. In some cases, options such as a leg configuration of freestanding product may be constrained for compatibility with another systems or freestanding product.

Complex or highly configurable products may be specified using a client based product specification computer program. This program is an industrial design tool that typically runs on the user's local computer or local network and is used to specify highly configurable or complex products, such as office furniture. An exemplary computer system for use with the disclosed embodiments is a computer having a Pentium™ class processor running at 400 MHz or faster, such as a Celeron™, Pentium™ III or Pentium™ IV processor, a hard disk with at least 5 GB, 128 MB of memory, a CD-ROM drive, mouse pointer and a display capable of displaying a minimum resolution of 800×600 with 16 bit color depth. It will be appreciated that there are many suitable computer configurations and peripheral devices which may be used with the disclosed embodiments, now or later developed. An exemplary client based visual product specification program is “Z-Axis®: The Next Generation”, distributed by Herman Miller, Inc., located in Zeeland, Mich., referred herein as “Z-Axis®”. Z-Axis® permits a user to design a custom furniture layout of furniture systems and freestanding products marketed by Herman Miller for an office or other environment and visualize that layout in both two and three dimensions. Further, the user can specify colors, fabrics and other options and visualize how these will appear on the actual products. Anytime during the design process, the user can generate a bill of materials (“BOM”) which lists all of the products required to be purchased from the supplier in order to create the designed layout. This bill of materials may also be generated as a data file formatted as a SIF file (an office furniture industry standard format), which allows simplified error-free ordering from manufacturers.

In one embodiment, Z-Axis® provides a graphical user interface, displayed on the display device coupled with the computer running the program, which is not overly complex and which is tailored to the application of creating design layouts involving complex highly configurable furniture products. The graphical user interface interacts with the user by displaying output, feedback and prompts using graphical interface elements, such as menus, buttons, dialog boxes, etc. Input and responses are received from the user via the input devices coupled with the computer such as the mouse pointer and keyboard. Other input devices, such as tablet based computers, personal digital assistants, touch sensitive displays, scanners and other digital imaging devices, etc. may also be used. The interface provides intuitive menus and functions, high quality displays of the design and products, standardized interface elements and simplified operation, all of which permits the user to focus on the creative design process rather than figuring out how to utilize the product specification program or requiring in-depth knowledge of the products being configured.

In particular, the interface provides a window display having multiple portions or panes. In one embodiment, the primary display presents at least four panes, each of which is fixed in size and relationship with the other panes. In alternative embodiments, the panes may be separately manipulated with respect to size and display position. The multi-pane display permits the interface to intuitively and simultaneously display all information for given user operations. Each pane provides a sub-set of the overall functionality of the interface. Further, the actions and functions of one pane may interact and affect the actions and functions of one or more of the other panes, as will be discussed below.

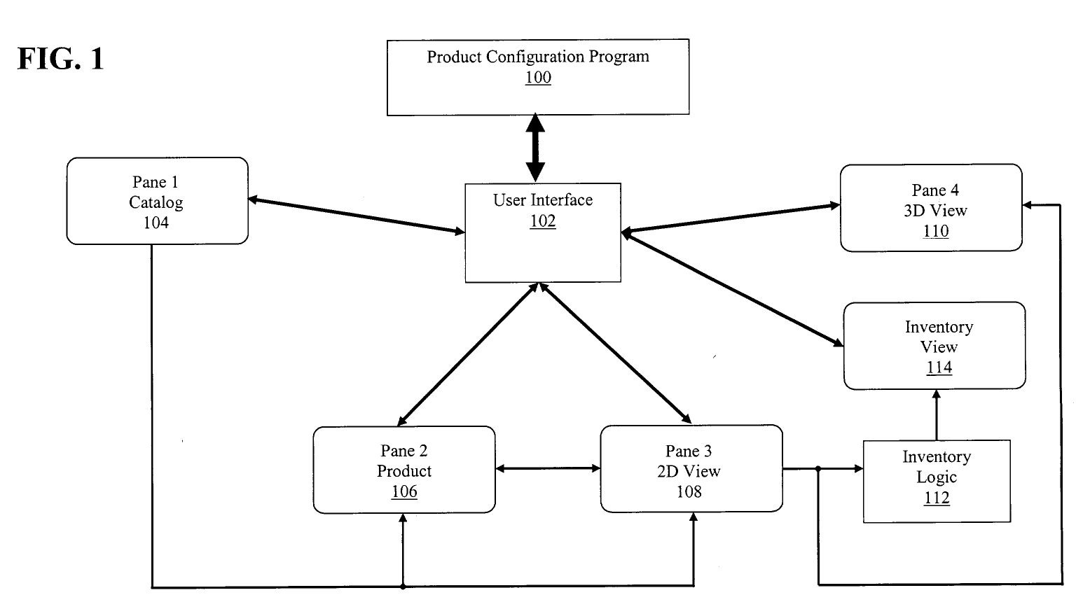

FIG. 1 shows a block diagram of a product configuration program 100 coupled with a graphical user interface 102 according to a first embodiment. Herein, the phrase “coupled with” is defined to mean directly connected to or indirectly connected through one or more intermediate components. Such intermediate components may include both hardware and software based components. The user interface 102 includes a display (not shown) having 4 portions or panes including a product catalog/function pane 104, a product information/manipulation pane 106, a two dimensional plan/top view display pane 108 and a three dimensional display pane 110. Further the program 100 includes inventory logic 112 which interfaces with the user interface to generate an inventory of products that have been placed and/or assembled, including required additional products such as connectors, which can be viewed in an inventory display 114.

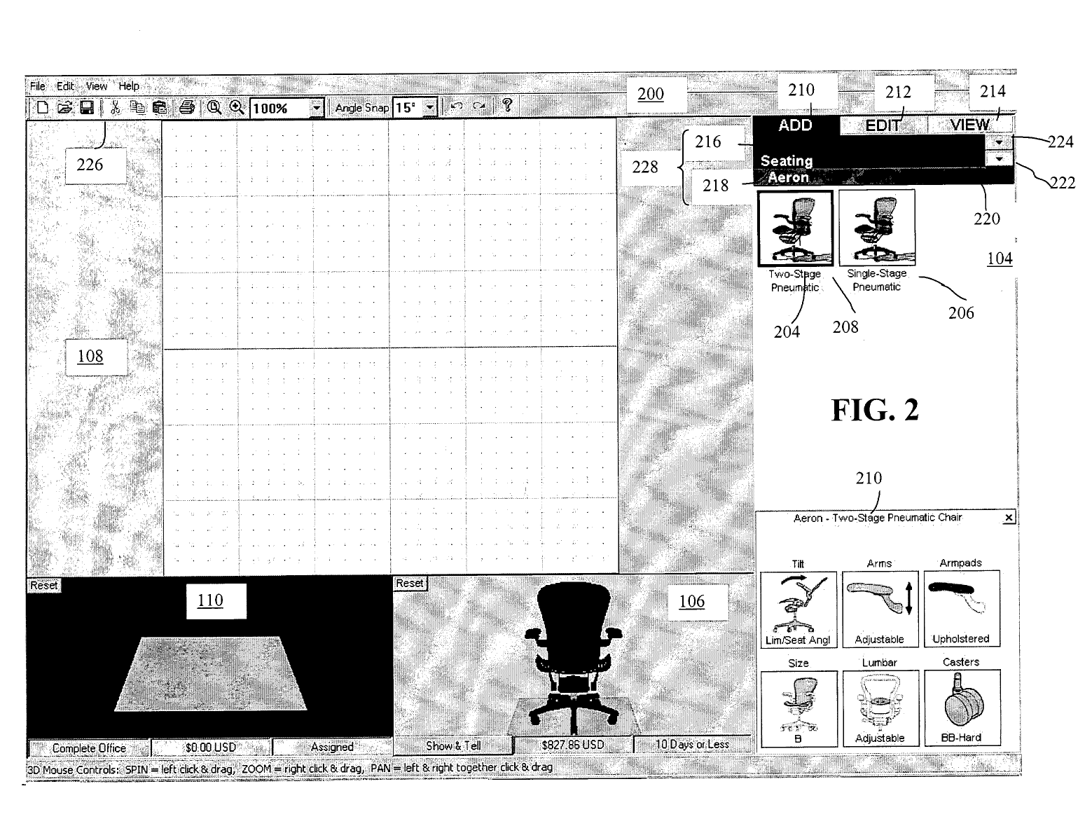

FIG. 2 shows an exemplary graphical user interface 102 display 200 for use with the embodiment of FIG. 1. The display 200 includes the product catalog/function pane 104, a product information/manipulation pane 106, a two dimensional plan view display pane 108 and a three dimensional display pane 110. The display 200 further includes a menu/tool bar 226 including pull down menus and buttons, the buttons providing basic program operation functions such as new design layout, open existing design layout, cut, copy, paste, print, zoom, set angle snap, undo, redo and help. Further, the pull-down menus include a file menu, edit menu, view menu and help menu. The menus and function of the menu/tool bar 226 provide access to standardized operating system functions as well as to the functions, or a subset thereof, detailed below. Each of the panes 104, 106, 108, 110 will be described in more detail below.

The product catalog/function pane 104 provides three primary functions, configuring and adding products to a design layout 210, editing various aspects of the design layout 212 and viewing alternate aspects of the overall design layout 214. Generally, the product catalog/function pane displays a hierarchical/layered structure 228 of selectable items 204, 206, 216, 218, 220, 222, 224 representing functions, such as links to other levels of the hierarchy 228, or products 204, 206. As a user selects one of these selectable items 204, 206, 216, 218, 220, 222, 224, a new set of selectable items associated with the first selection is displayed (not shown). In addition, the selection is represented in a hierarchical/layered display 228 which shows, i.e. maps, all past selections in the current navigation path. Each of the layers 216, 218, 220 in the hierarchical/layered display 228 is itself selectable and allows the user to asymmetrically move around their current navigation path. For example, the user first selects the add function 210, described below, and is presented with the top level in the hierarchical product catalog, with the add selection 216 indicated in the hierarchical/layered display 228. As the user navigates down through the hierarchy of product types, product lines and the various other product categories, each hierarchical selection is further added to the hierarchical/layered display 228. At any time, the user may click on one of the layers and, essentially, backtrack along their navigation path at any level.

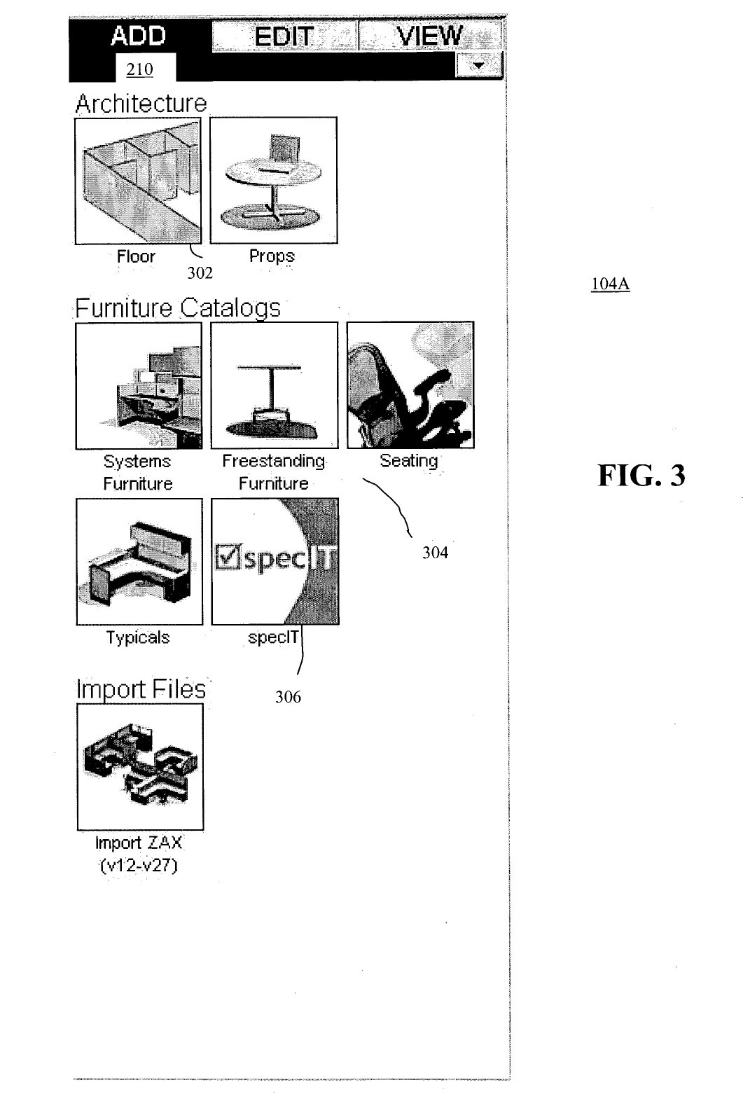

FIG. 3 shows an exemplary graphical interface window pane 104A for use with the graphical user interface of FIG. 2 for displaying a product catalog. The displayed pane 104A shows the top level of the product catalog for the add function 210. This display 104A permits the user to define the parameters of their design layout using the Floor function 302. This function permits the user to define the dimensions of the space they are planning as well as layout architectural features such as fixed walls, columns, doors and windows, and/or, import building shell information/layouts from other sources such as CAD software programs. The various available furniture catalogs 304 are available as well. As was described above, furniture products are commonly classified by the categories of system furniture, freestanding furniture, and seating. Typicals is an option which allows a user to either select from pre-built furniture layouts as provided by the manufacturer, or to customize their own pre-built configuration from products available in this and other catalogs. This function assists the user in standardizing design layouts and adhering to design guidelines. The shopping cart function 306, in one embodiment known as “specIT”, links a user to another application which is primarily text-based and allows for the specification of products not contained within in the Z-Axis® application catalog database. Products that are specified through this application are returned to Z-Axis®, made visible on the order/inventory list, and included as part of the SIF order file. Other functions may also be provided such as an import function which allows the user to import a design from another version of the software or a function which allows the user to place accessory items to be visually represented in the design to aid the placement, layout and arrangement process, such as by providing visual cues or a measure of realism. Accessory items may include general furniture such as sofas, lounge tables, etc., plants, waste baskets, computers, etc. Accessory items are included in the Product Order but set off in a delineated section.

Referring back to FIG. 2, the product catalog/function pane 104 is shown displaying an exemplary add function 210 display. The pane 104 includes available products 204, 206, in this example two different chairs. Further, the display pane 104 indicates that one of the chairs 204 has been selected by the user as indicated by the selection rectangle 208 that is darker/thicker than the normal image border. For the selected product 204, the display pane 104 further displays available configuration options 210, such as the available tilt options, available arm options, available arm pad options, available sizes, available lumbar options and available caster options. Each option 210 is selectable and causes display of the available alternatives (not shown) by a suitable graphical interface element, such as a dialog box or pop up display, etc.

The add products function 210 is used in conjunction with the product information/manipulation display pane 106, the two dimensional plan view display pane 108 and the three dimensional view pane 110. The add products function 210 displays the available products that can be configured and placed in a given design layout. The products are displayed as an electronic catalog having both a visual and logical hierarchical structure. This structure is typically organized based on the way the products are offered by the manufacturer, as described above, such as by freestanding, seating or system product, product line, product type, etc. as shown in FIG. 3. The user utilizes the interface 102, 104 to navigate through the catalog hierarchy to locate desired products. In one embodiment, short-cut navigation functions or search functions may be provided to assist the user in navigating through the catalog and locating particular products. In an alternate embodiment, the catalog provided in the product catalog/function pane 104 is a subset of the products offered by the manufacturer(s). Once the user has selected a product for placement in the design layout, the product catalog/function pane 104 displays any optional configuration parameters 210 for that product, such as color, fabric type, optional accessories and available component substitutions. The selected product may be pre-configured with a default configuration which the user may alter or use without alteration. Where a product has no options, no configuration will be shown or allowed in the catalog/function pane 104. Further, as will be discussed below, the product information/manipulation display pane 106 is updated to display a three dimensional view of the selected product as well as product specific information such as price 806 and manufacturing lead time 808. As the user alters the product configuration in the product catalog pane 104, the information displayed in the product information/manipulation display pane 106 is dynamically updated to reflect the changes. Once the user has selected and/or configured the product, they can add it to their design layout. In one embodiment, the user utilizes their mouse pointer to “drag” a representation of the configured product onto the two dimensional plan view display pane 108. Functions are also provided to allow the user to add multiple instances of the product to the design layout without having to individually select and place each occurrence. As will be discussed, the addition of a product to the design layout causes a representation of the product to appear in the two dimensional plan view display pane 108 in the location chosen by the user. As used herein, the term “location” is used to refer to an object's spatial position, orientation or both. Generally, an object's position is a representation of the area or volume that it occupies in absolute or relative relation to a known origin or reference or within a known coordinate system, e.g. linear distance from a fixed object. An object's orientation is a representation of its arrangement/alignment in space within its position in absolute or relative relation to a known origin or reference, e.g. angle relative to the floor. It will be appreciated that there may be many ways to define an objects location (position and/or orientation) within a given space. Further, as will be discussed, the three dimensional display pane 110 is dynamically updated to reflect the addition of the product(s) as configured.

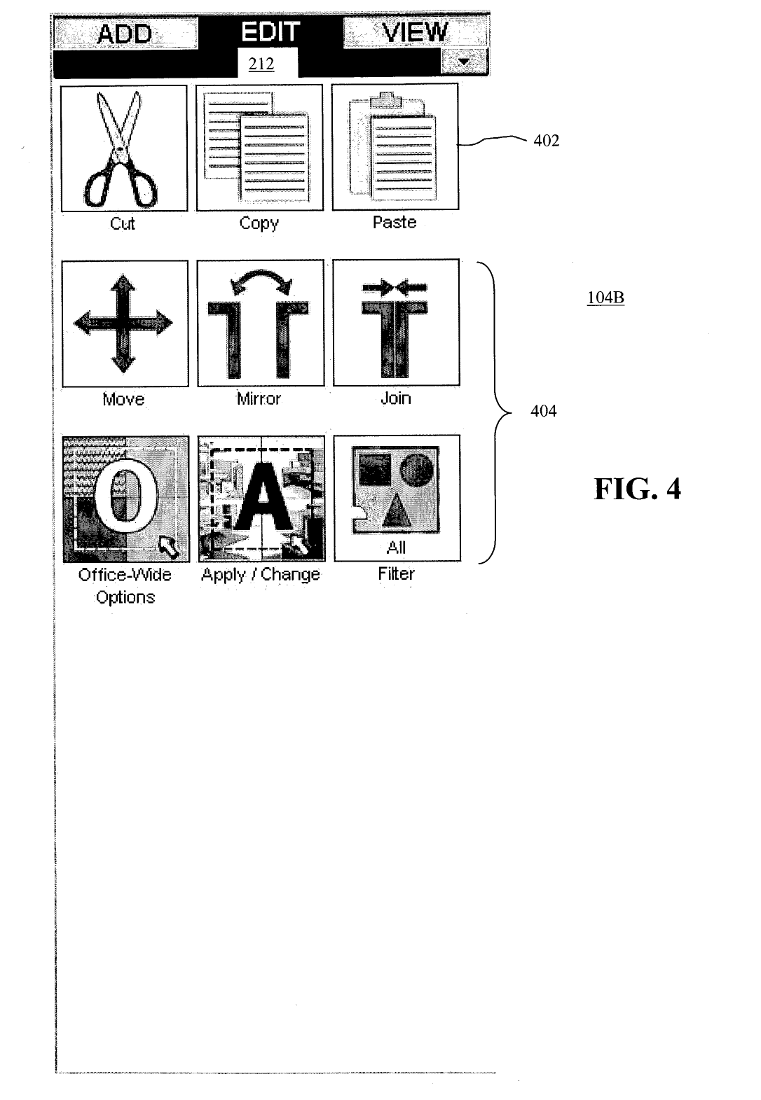

FIG. 4 shows an exemplary graphical interface window pane 104B for use with the graphical user interface of FIG. 2 for displaying an edit function menu 212. The pane 104B displays the available functions which, in one embodiment, may be categorized as basic commands 402, and specialized commands 404. The basic commands 402 include cut, copy, paste and move. In an alternate embodiment, a delete function may also be provided. The specialized commands 404 include mirror, join, office-wide options, and apply. A filter function may also be provided which permits the user to filter the Edit selections to include, for example, just furniture items, just floor/architectural items or all items. When activated, the filter prevents user from selecting the filtered items when using the provided selection mechanisms, i.e. drawing a selection box or directly clicking on an item.

The edit design layout function 212 is used in conjunction with the product information/manipulation display pane 106, the two dimensional plan view display pane 108 and the three dimensional view pane 110. The edit design layout function 212 provides functions which allow the user to edit their current design layout. Such functions include basic commands 402 such as cut, copy, paste and move, all of which can be used to edit the various products, singularly or collectively, currently included in the design layout. In an alternate embodiment, a delete function may also be provided. Other commands 404 are also available such as mirror and join. The mirror function is used to change products in a design layout in a complementary fashion. For example, to add two back to back identical workstations, the user need only add the first workstation, copy it, and then use the mirror function to mirror the orientation of one of the workstations. The mirror function not only changes the visual orientation of a workstation but also computes the necessary parts, or omission thereof, to effect the arrangement, i.e., assemble the component parts. For example in certain configurations, there may exist products with a left or right handed orientation. The mirror function will properly substitute the correctly oriented product during execution of the mirror function. In cases where an equivalent product in the selected orientation is not available or the product to be mirrored is orientation independent, the mirror function may simply move and rotate a product in the intended position. The join command allows a user to select two products, having the characteristic/capability to be joined, i.e. assembled together, already placed in the design and join them together, automatically computing the necessary parts, i.e. additional products, or omission thereof, necessary to effect the arrangement/assembly. In both the mirror and join functions, improper arrangements, i.e. those arrangements that are either not manufacturable, not available or, in some cases, not recommended, are detected and indicated to the user, such as by a visual or audible warning indicator, dialog box or the disabling of the particular function. To use the basic edit and mirror functions 212, the user selects one or more products in the two dimensional plan view display 108, such as by drawing a selection box around them or clicking on them with the mouse pointer. Once selected, the user then selects the appropriate basic edit or mirror function 212. Other edit functions, including join, office-wide options, and apply, do not require pre-selection of the products to be edited. The apply function 404 provided by the edit function 212 include a function to selectively alter the configuration/specification of selected individual products, or groups of products, and simultaneously apply changes to them. This includes, but is not limited to, changing product height, power and circuitry. Another edit function is office-wide options which allows an easy way to get all of the products within a product line to have properly matching features such as fabric or style, or work surface edge type.

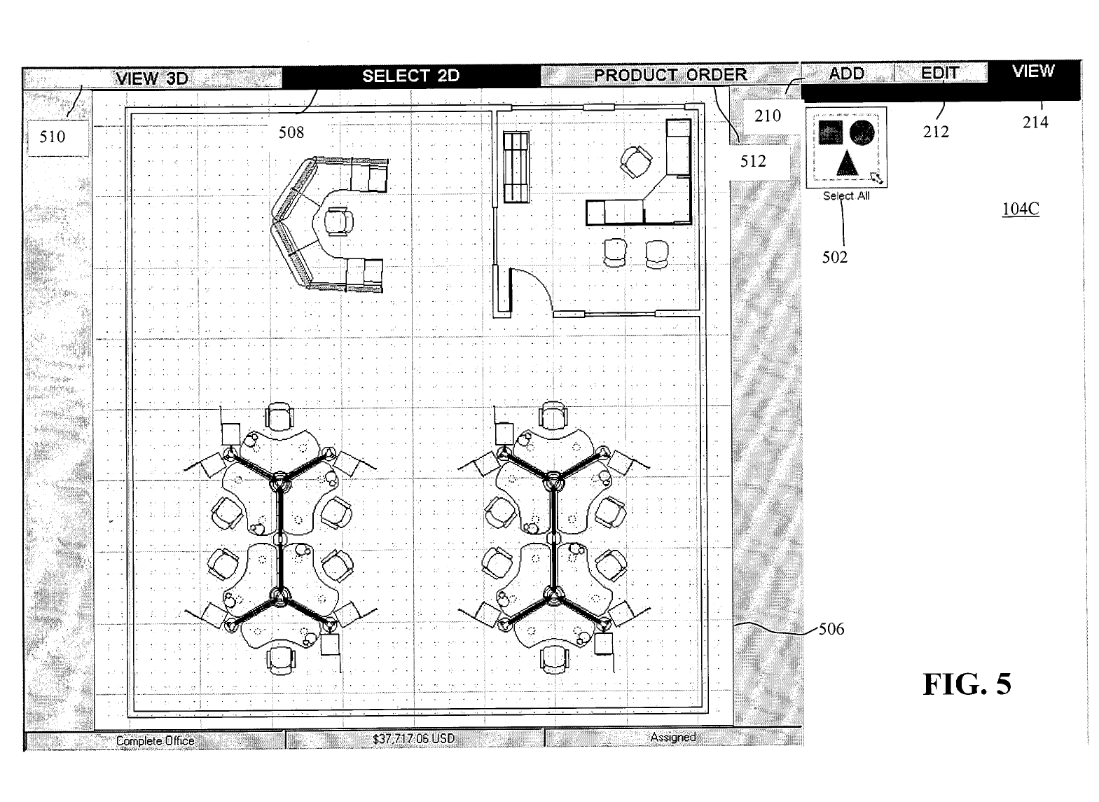

FIG. 5 shows an exemplary graphical interface window 104C for use with the graphical user interface 200 of FIG. 2 for selecting a portion of a design for viewing. This window 104C is displayed when the user chooses the view function 214 in the product catalog/function pane 104 and then chooses the select mode 508. The window 104C includes a two dimensional plan view 506 of the current design layout and provides functions for selecting all 502 of the layout for viewing in the other modes 510, 512. To select a portion of the layout, the user simply either draws a rectangle around the desired portion, or individually selects products/configurations, in the two dimensional plan view 506 using the mouse pointer.

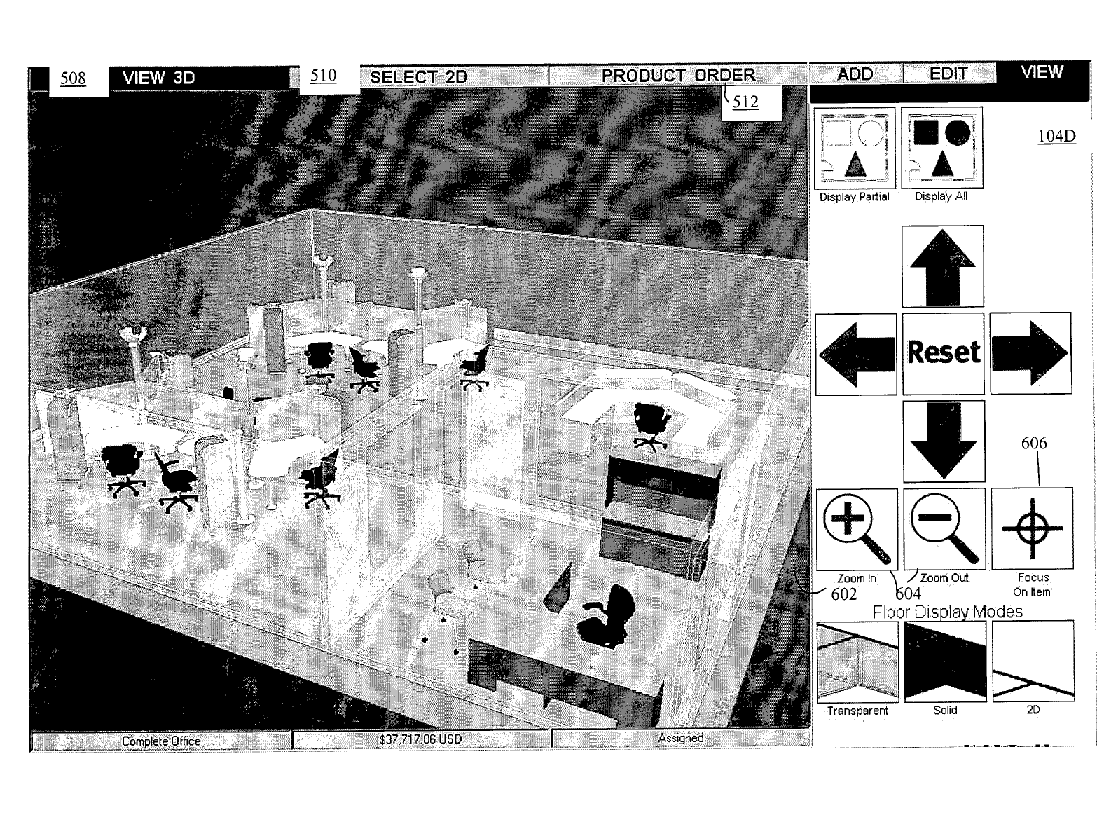

FIG. 6 shows an exemplary graphical interface window 104D for use with the graphical user interface 200 of FIG. 2 for displaying a three dimensional view of all, or a selected portion of a design. This window 104D is displayed when the user chooses the view function 214 in the product catalog/function pane 104 and then chooses the view 3D mode 510. The window 104D includes a three dimensional view 602 of the selected portion of the design layout, selected in the select mode 508 (FIG. 5). If the user did not select a particular portion, then the three dimensional view 602 shows the entire design layout. The window 104D provides control functions 604 for rotating, panning and zooming the three dimensional view 602. Further, a spotlight function 606, also referred to as a “focus” or “target” function, is provided which allows the user to alter the focal point of the rotate, pan and zoom functions. In one embodiment, the focus may be set on any particular item in the design. In an alternate embodiment, the focus may be set on any arbitrary point within the design. Where the user has selected a portion of the design for display, a toggle function is provided to toggle between the partial selection 3D view and a 3D view of the entire design. Further, toggle functions are provided to control the appearance of architectural features, such as doors or walls, to best view the design. As described below, the user may select to view these features as transparent/skeleton, in solid fill or indicated with 2D representations of their physical location shown on the floor plan.

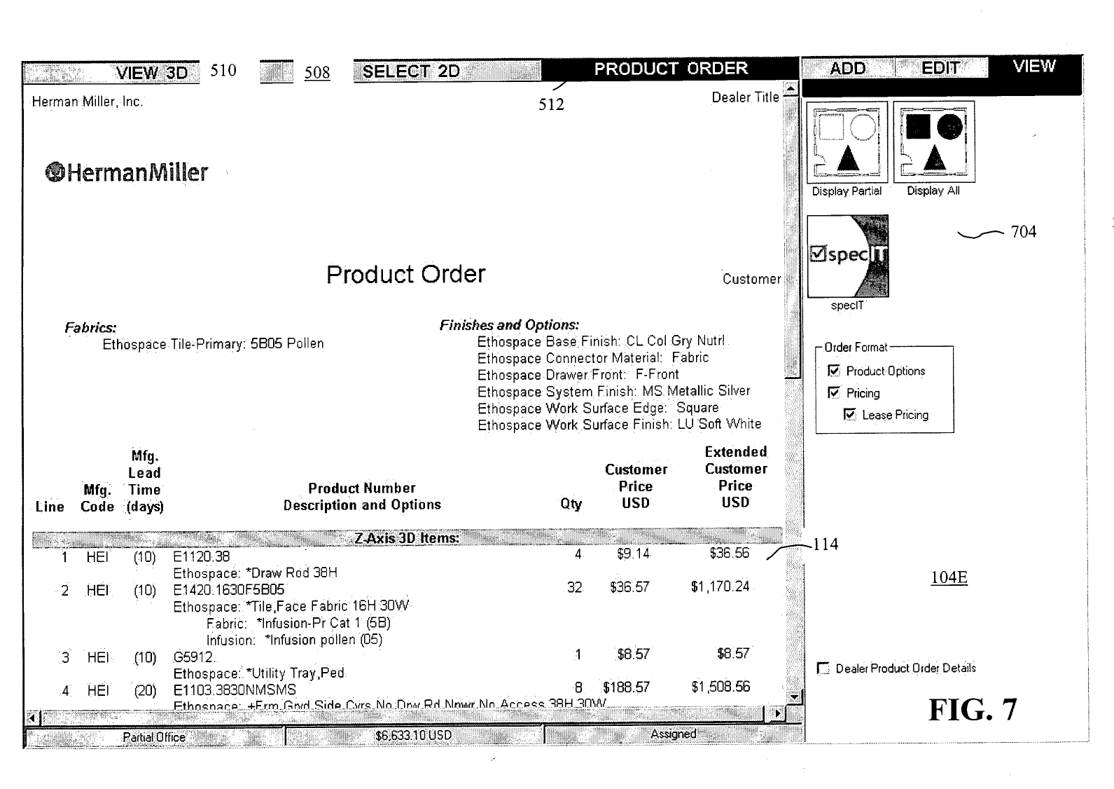

FIG. 7 shows an exemplary graphical interface window 104E for use with the graphical user interface 200 of FIG. 2 for displaying an inventory list 114 of products included in the current design, or the selected portion of the design. This window 104E is displayed when the user chooses the view function 214 in the product catalog/function pane 104 and then chooses the Product Order mode 512, also referred to as the inventory view mode. The window 104E provides various methods for turning on and/or off certain aspects of the report, such as product options, pricing, and lease information. There is also an option to launch a separate application(s), such as the specIT application described above, for configuring additional products that the user wishes to have included in the report. The inventory list 114 is generated from a product inventory database which maintains an inventory of all products in the current design, including products which may not be visually represented on the display, for example certain internal connectors or other parts necessary to join two other products together. As products are added or removed from the design, whether directly by the user, or as a result of user actions, such as use of the join or mirror commands described above, the inventory database is automatically updated. Where the user has selected a portion of the design for which to view the inventory for, toggle functions are provided which allow the user to toggle between viewing the inventory for the selection only or for the entire design.

The view design layout function 214 hides the product information/manipulation display pane 106, the two dimensional plan view display pane 108 and the three dimensional view pane 110 and provides a separate display window 506, 602, 114 for displaying the various available views 508, 510, 512. The view design layout function 214 provides three operation modes, select mode 508, three dimensional view mode 510 and Product Order/Inventory view mode 512. The select mode 508 is used to determine what will be displayed in the other two modes. This mode allows the user to work with a user-specified subset of the current design layout if they so choose. The select mode 508 presents a two dimensional plan view 506 of the current design layout and provides function 502 which allow the user select a subset of the design layout for viewing. The user may select a portion of the layout by drawing a box around the desired portion, or by pointing and clicking to select individual products. In an alternate embodiment, the user may specify selection criteria, such as by specifying that all chairs are to be selected, using a dialog box or other user interface element. The three dimensional view mode 510 displays a three dimensional representation of the current design layout, or selected portion thereof. If the user has defined physical landmarks or other fixed features, such as walls or doors, these will be projected in two and/or three dimensions as well, depending upon the source of this data. In one embodiment, imported building shell data is represented in two dimensions while features added using the specification program are displayed in three dimensions. In an alternate embodiment, all fixed features may be displayed in two or three dimensions, as well with transparent or non-transparent. The three dimensional view mode 510 provides a close approximation of what the actual design layout will look like when physically implemented. Functions 604 are provided which permit the user to rotate, zoom in and out and pan the display as well as a function 606 which allows the user to define the focal point of these operations 604. The Product Order/inventory view mode 512 provides an inventory list 114, i.e. a bill of materials, of all of the products in the current design layout, or selected portion thereof, i.e. the current order. The inventory list 114 is automatically created and maintained as the user adds and manipulates products in the other add or edit modes. The Product Order/inventory view mode 512 provides functions 704 which allow the user to view the inventory and order the listed products.

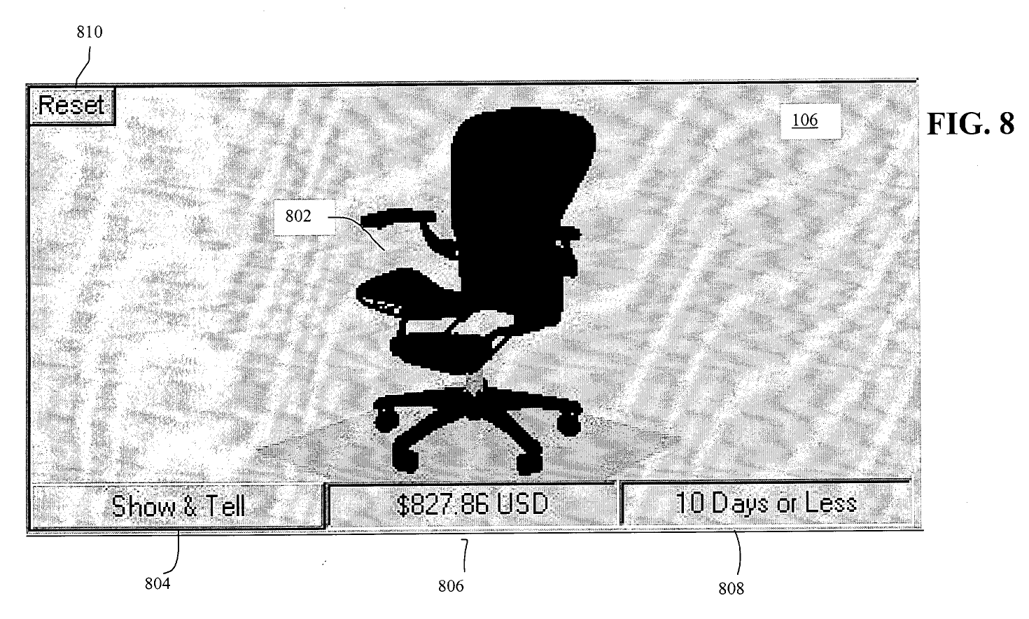

FIG. 8 shows an exemplary graphical interface window pane 106 for use with the graphical user interface 200 of FIG. 2 for displaying a three dimensional view 802 of a selected product. The three dimensional image 802 may be of high quality or quality suitable to give the user a close approximation as to what the product physically looks like. The pane 106 further displays the cost of the product as currently configured 806 and the manufacturing lead time for the product as configured 808. The user may interact with the pane 106 to zoom, pan or rotate the image 802. A reset function 810 is provided to reset the image to a default state. In addition, in one embodiment, a link 804 is provided to further information about the selected product. This information may be locally or remotely based. In one embodiment, the 804 is a hypertext link to product information located on a web server on the Internet or an intranet and activates a browser client session when selected.

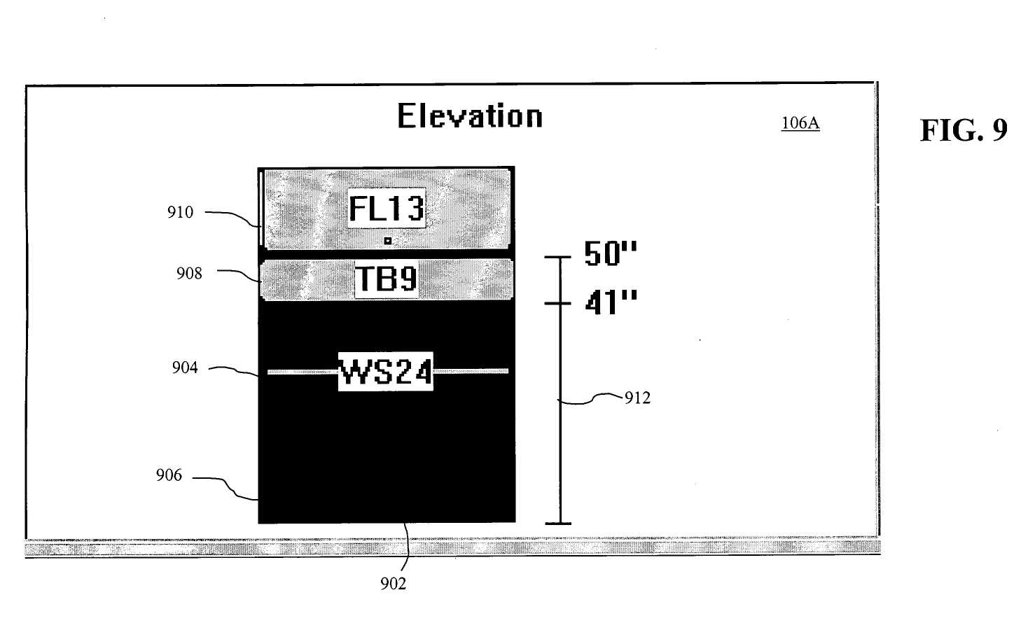

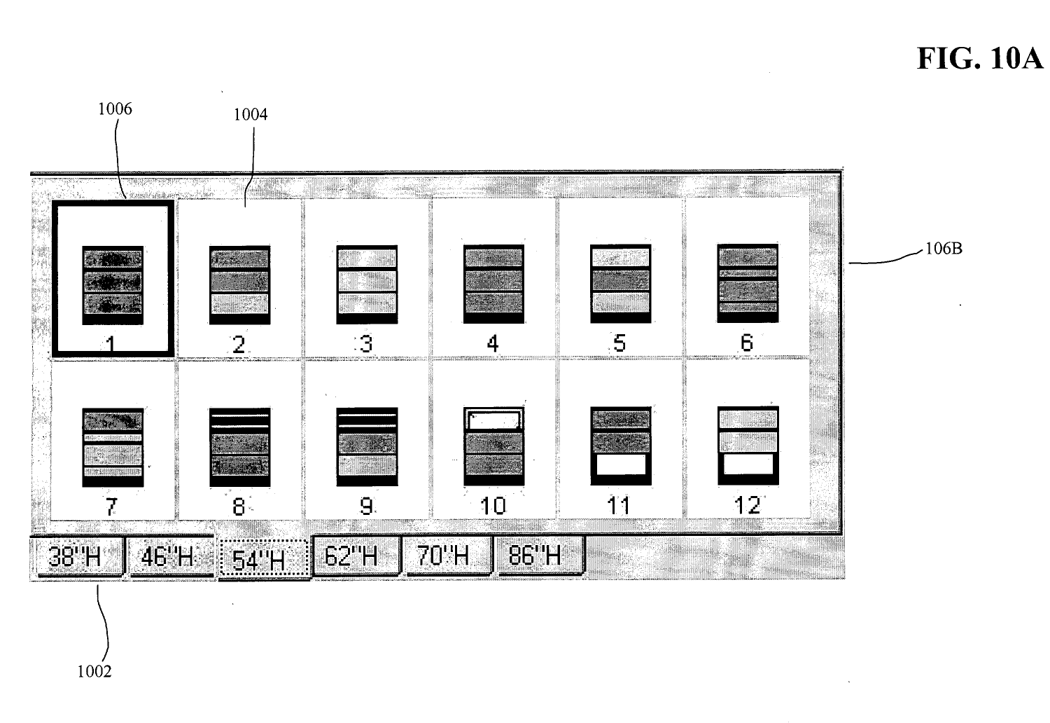

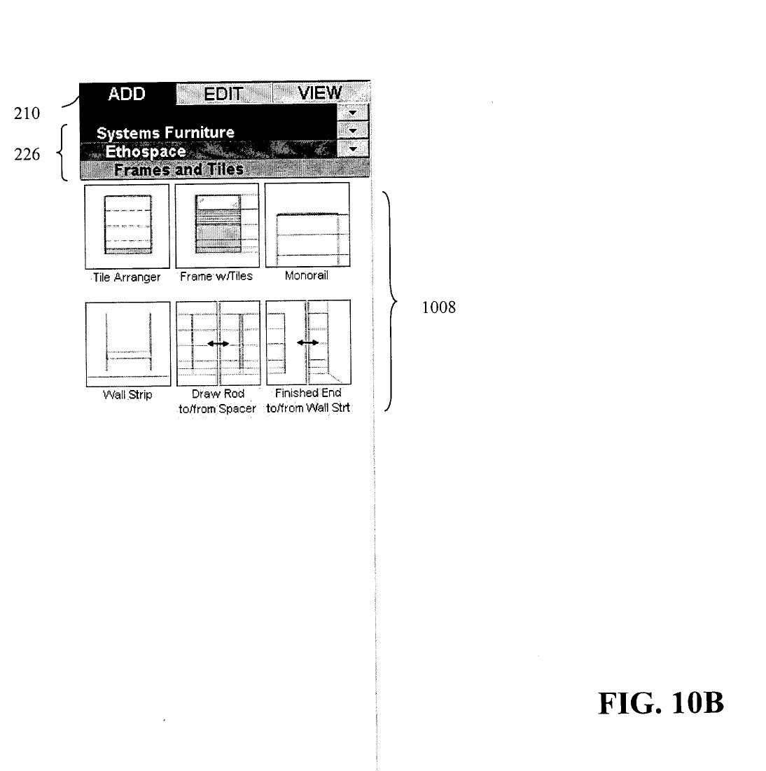

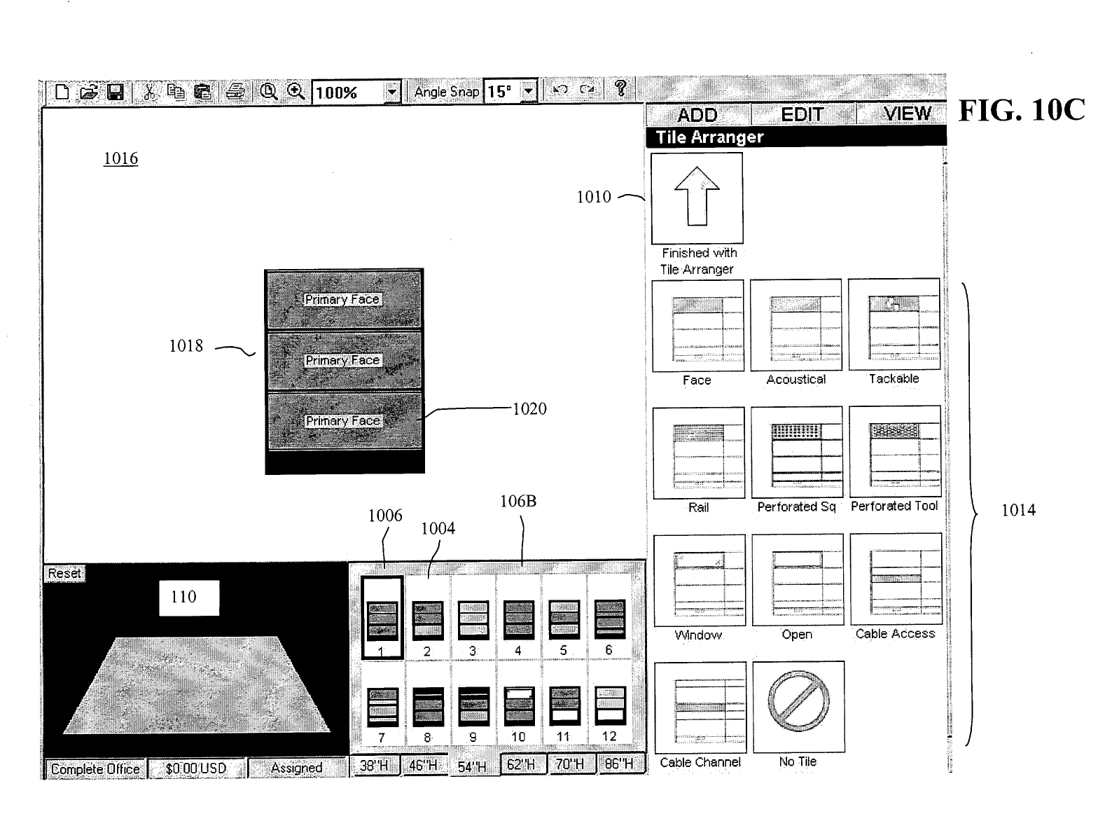

The product information/manipulation display pane 106 provides three modes of operation, product information (shown in FIG. 8), product to product manipulation (shown in FIG. 9) and a internal product manipulation (shown in FIG. 10). Each mode is automatically determined based on the context of the operations the user is attempting to perform. As shown in FIG. 8, in product information mode, the product information/manipulation display pane 106 displays information specific to the currently selected product(s), selected in either the two dimensional plan view display pane 108 or the product catalog/function pane 104. This information includes a three dimensional image 802 of the selected product(s) with the designated configuration or optional parameters. This image may be zoomed, panned and/or rotated by the user. In an alternate embodiment, the ability to view the interior of a product is provided. The image 802 is intended to show the user a close approximation of the actual product. In addition, the information also includes data such as the manufacturing lead time 808 and cost 806 of the product as configured. As the user alters the configuration of the product, the image 802 and the lead time 808 and cost 806 information are dynamically updated. In addition, selectable links 804 may be provided which link the user to additional information about the product. Such additional information may be provided on the Internet via the World Wide Web, wherein selecting the link activates a web browser client program and directs the browser to a particular web site and/or web page where the additional information is provided.

FIG. 9 shows an exemplary graphical interface window pane 106A for use with the graphical user interface 200 of FIG. 2 for displaying a product attachment and position interface 902 for a selected product. The pane 106A shows an elevational representation of the product 906, e.g. a panel/wall, to which the selected product 904, e.g. a work surface, is going to be attached. In addition, other products 908, 910, e.g. storage products, which have been previously attached at default locations are also displayed. An indicator 912 of the position of the attached products 904, 908, 910 is also displayed for the users positional reference. In this exemplary display, the indicator 912 shows the height, relative to the floor or bottom of the panel/wall 906, of the attached products 904, 908, 910.

The product to product manipulation mode is used when the currently selected product is to be assembled, i.e., attached/connected, with another product which has been previously placed in the design. This mode may also activate when the user attempts to connect two or more previously placed products. For example, when adding a work surface product to the design, the work surface is typically attached to a panel/wall product. In this mode, the product information/manipulation display pane 106A displays a representation 902 of the two products 904, 906, i.e. the work surface and the panel/wall, as they are attached, such as an elevation view. Further, if other products have been previously attached, they will be displayed as well. The product information/manipulation display pane 106A provides functionality which allows the user to change the attachment position, e.g. height, of the selected product relative to the product it is attached to, such as the mounting height or depth, or other location. For example, the user may drag the selected product to a desired position. This functionality further detects and prevents improper positioning of the products, also known as collisions. For example, the functionality will not allow the user to place the selected product where another product is already attached. Further, this functionality will not allow the user to place the selected product in an improper or illogical position, such as a position where it cannot be assembled or for which is not manufacturable or not available, i.e. mounting holes do not exist in the desired position. Such improper positioning, when detected, may result in the display of a warning indicator, in the selected product jumping to then next closest proper position or in the inability for the user to complete the function. Once a position of attachment is defined, the three dimensional view pane 110 is appropriately updated to reflect the new positions/arrangement.

FIGS. 10A-10C shows an exemplary graphical interface window pane 106B for use with the graphical user interface 200 of FIG. 2 for displaying and configuring a selected product(s) having multiple components or additional products. The exemplary pane 106B shown related to configuring panels/frames/walls and the various available tiles which can be used in the construction of the panels/frames/walls. Tabs 1002 are displayed for the available panel/frame/wall heights. Within the various available heights, available panel/frame/wall configurations 1004 are displayed. The user may select an available panel/frame/wall configuration 1004, as shown by the selection indicator 1006 and then modify the configuration as desired.

The internal product manipulation mode is used to configure products that include other products as sub-components. For example, panel/wall products are composed of a frame and several tiles which are attached to the frame. The user has many choices as to the number of and types of tiles which may be included and/or excluded in a given panel/frame/wall section and which may depend on factors such as the panel/wall width or height, including fabric covered tiles, marker board tiles, tackable tiles, and open tiles. The function also provides the capability to purposely exclude any tile type from being located in a given position(s). The internal product manipulation mode provides tools to allow the user to construct a custom combination of sub-components from those available and then add this custom designed product to their design layout. This mode is entered by selecting an icon from the catalog, such as the tile arranger icon which is used for a frame and tile product line as shown in FIGS. 10B and 10C.

In an alternate embodiment, a custom product configuration mode (not shown) is provided. This mode allows the user to design a completely custom configuration of a given product. For example, wherein the product catalog offers only particular widths of work surfaces, the custom product configuration mode allows the user to design a work surface with a custom width. Other features may also be customized such as the shape, finish, edging, or cable routing features of the work surface. In addition, other products which may be customized include panel/wall covers, such allowing the specification of custom designs or images, or storage towers, such as allowing custom arrangements of storage tower components. In either case, the custom product configuration mode provides the user with the ability to custom specify a product limited only by the manufacturer's ability to manufacture that product rather than by limitations of the specification computer program 100, such as the product catalog. Once the user has designed their custom product, they may add it to their design layout using all of the available functionality of the specification program 100. Further, once added, the custom products are appropriately represented in both the two dimensional plan view 108 and the three dimensional display panes 110. Ordering information for the custom products may also be provided.

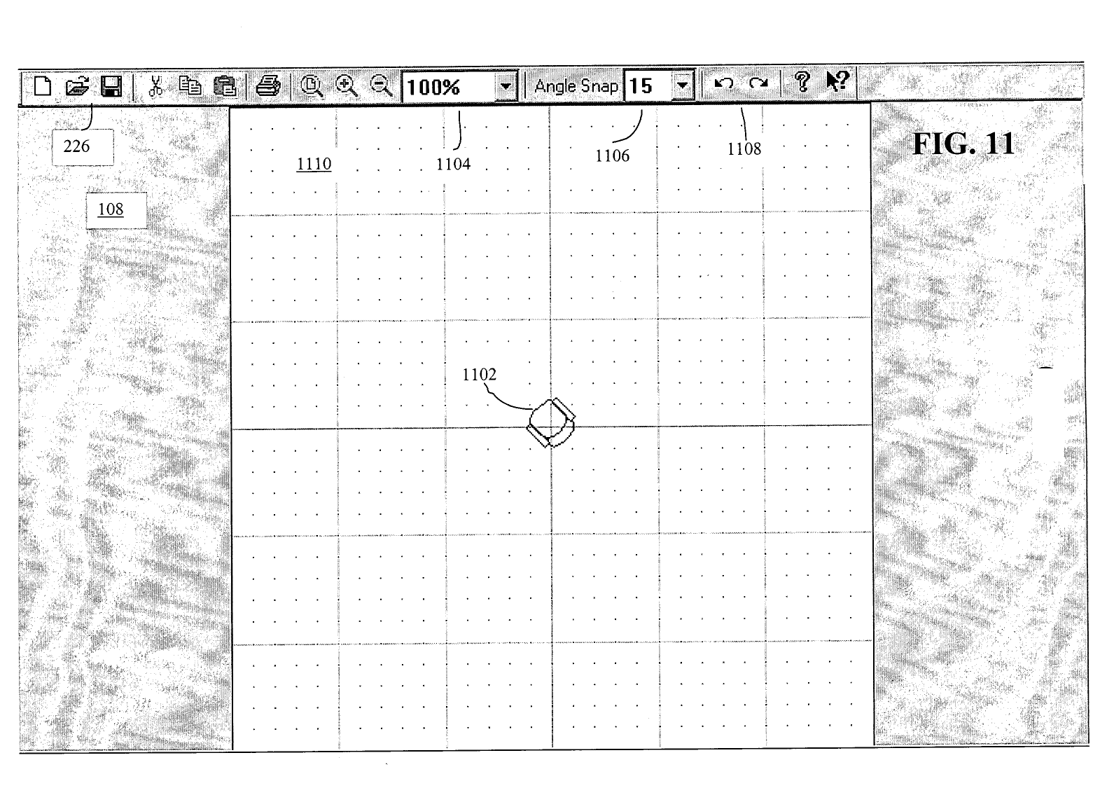

FIG. 11 shows an exemplary graphical interface window pane 108 for use with the graphical user interface 200 of FIG. 2 for displaying a two dimensional plan view of a design layout. The pane 108 includes a display grid 1110 on which the graphical representations 1102 of the products are shown. Further, a zoom function 1104 and undo/redo 1108 functions are provided. The menu/tool bar 226 features an angle snap function and a zoom function, the increments of which may be set by the user.

The two dimensional plan view display pane 108 provides a top down (also known as plan) view of the current design/office layout/floor plan. Further this pane 108 defines the main/primary interface for placing, assembling and manipulating products within the design layout. The display pane 108 includes an area representing the floor which includes a display grid showing relative distances. A user may define (or import) architectural features such as walls, windows or doors to closely approximate a given floor plan. As products, as configured, are placed in the design, they are represented by graphic/architectural symbol s/representations 1102. These symbols 1102 are displayed at the location, and in the position and rotation, chosen by the user. The display pane 108 further provides the user with the ability to zoom and pan the design layout. Further, undo and redo functions are provided to assist the user in placing products and creating office layouts. The undo/redo function 1108 allows the user to undo operations or product placement while the redo function permits the user to undo the undo function or restore the office layout to a prior state. The undo/redo function 1108 may provide multiple levels allowing the user to back-up (or restore) through multiple past operations. In addition, an angle snap function 1106 is provided. The angle snap function 1106 provides an invisible grid which constrains the placement angle and/or orientation of products to fixed increments, thereby simplifying the alignment of product angle and/or orientation within the design layout relative to other products, architectural features or other known origin. These fixed increments may be adjusted by the user to be courser or finer as dictated by the needs of the user. Similar to the angle snap function 1106, a grid snap function may be provided, in addition to or in place of the angle snap function 1106, which constrains the arrangement of a product to fixed increments, thereby simplifying alignment of product location within the design layout relative to other products, architectural features, or other known origin.

When adding products to the design layout, the two dimensional display pane 108 also provides visual cues to assist the user. For example, when placing a product, the mouse pointer may show a phantom representation of the product which follows the mouse pointer, allowing the user to easily visualize placement, alignment, orientation, rotation and size prior to completing the operation. Further, as these phantom representations are moved around the display pane, visual cues indicating their relationship with previously arranged products are displayed for the user. For example, when a phantom image of a yet-to-be placed work surface is dragged near a panel/wall that has been previously placed, the display pane 108 snaps the object to the panel/wall and thus indicates at least one potentially acceptable mounting location for the work surface, such as by highlighting the area to where the work surface may be attached. Further, configuration of some products may be dependent upon their relationship with other products which have already been placed and configured. For example, when attaching a work surface to a panel/wall, the length of the work surface must match the configured width of the panel/wall and/or its connectors. When placing such products, the display pane 108 automatically displays an indicator of a required configuration change when the phantom image of the product to be placed is brought in proximity to a suitable previously placed product. For example, where the user has selected a work surface of a given length and attempts to attach that work surface to a panel/wall with a different width, the display pane 108 automatically changes, i.e. stretches, the selected work surface to one with the proper dimensions and changes the phantom representation so that the user can see that a different work surface is necessary for the desired arrangement. If the user agrees with the change, they can place the changed product. Products connected with other products and which have variable mounting position, such as variable height, are initially connected at a default position, e.g. height, and the product to product manipulation mode, described in more detail above, is activated, allowing the user to alter the product position.

The two dimensional plan view display pane 108 is also linked with inventory logic 112 which generates the product inventory list 114. As products are added to or removed from the design layout, the display pane 108 informs the inventory logic 112 to appropriately adjust the inventory 114 for the current design. Further, when products are assembled together or separated, the display pane 108 automatically computes the necessary products and/or configurations to add or remove from the inventory 114 and updates the inventory logic 112 accordingly. For example, when one panel/wall is assembled to a second panel/wall, the display pane 108 computes the additional mounting hardware products necessary to complete the assembly, described in more detail above. Further, where two workstations are joined or separated, the display pane 108 computes the products necessary to add or delete to effect the arrangement. In this way, the user does not need to understand the complexities of the products they are using and the myriad component parts necessary to implement a given design. Any changes to the design layout effected by either the user or automatically by the various design tools are automatically reflected in the inventory 114 via the inventory logic 112.

As will be described below, the two dimensional plan view display pane 108 is also dynamically linked to the three dimensional display pane 110 to update the three dimensional view of the design and other displayed information as changes are made.

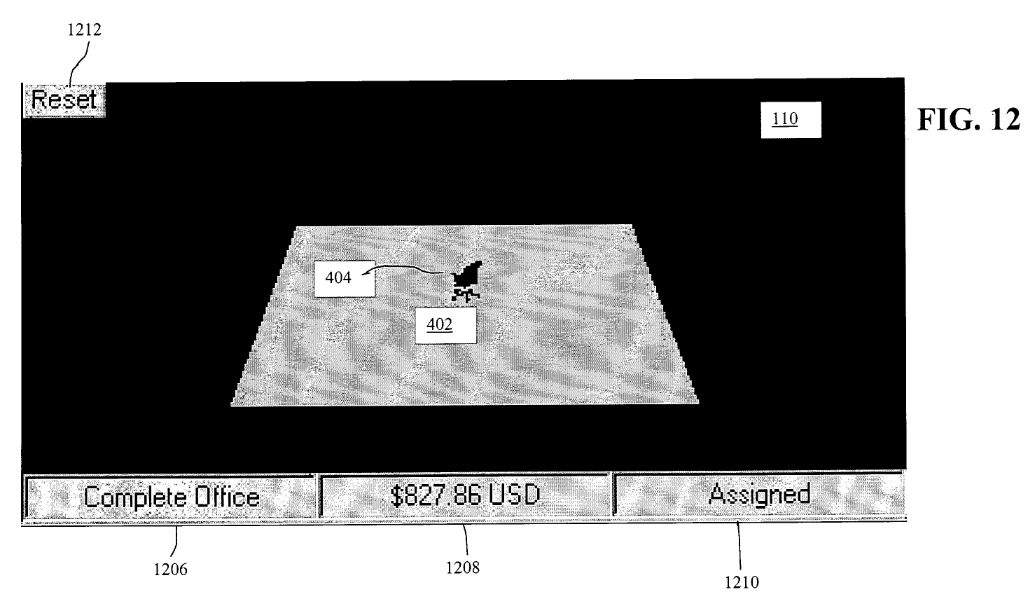

FIG. 12 shows an exemplary graphical interface window pane 110 for use with the graphical user interface of FIG. 2 for displaying a three dimensional view 402 of a design layout. The pane 110 shows a representation 404 of the floor along with all of the products currently visible in the design layout. In an alternate embodiment, customer specified products are also displayed. Using the mouse pointer, the user may zoom, rotate or pan the view 402. A reset function 1212 is also provided to reset the view 402 back to a default setting. In addition, the pane 110 displays a design caption/title 1206, the total cost of the current design layout 1208 and the overall lead time for the design layout 1210, i.e. the longest product lead time of all of the selected products in the design.

The three dimensional display pane 110 shows a three dimensional representation 402 of the current design layout as well as other overall parameters 1206, 1208, 1210 which are dynamically updated as the user makes changes to the design. The three dimensional display pane 110 also shows other information related to the overall design, such as a design title 1206, overall cost 1208 of the ordered selected products, and the overall manufacturing lead time 1210 for the order. The user may pan, zoom and rotate the representation for optimal viewing. In one embodiment, the user may alter the focal point of the pan, zoom and rotate functions. A reset function 1212 is provided to allow the user to reset the pan, zoom and rotation to default settings.

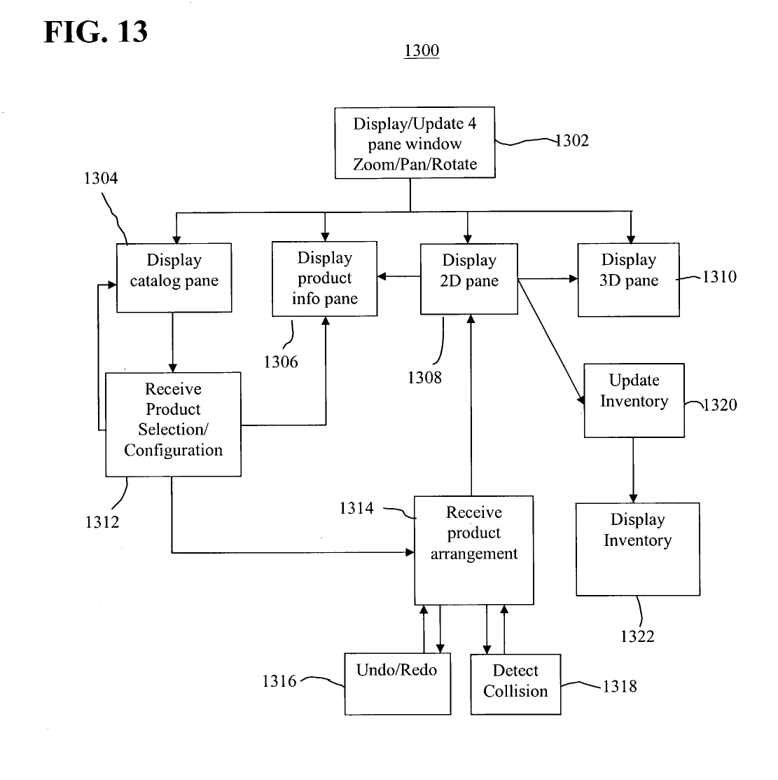

FIG. 13 shows a flow chart depicting exemplary operation of the graphical user interface 200 shown in FIG. 2. The multi-pane display is drawn/updated upon starting the program 100 and when updates to the displayed information occur (Block 1302). Each individual pane is displayed (Blocks 1304, 1306, 1308, 1310). Receipt of a product selection and/or configuration (Block 1312) causes the product information pane to display information about the selected product and configuration (Block 1306). The user may continue to select different products via the product catalog pane (Block 1304) or may choose to arrange the selected product in their design layout in the two dimensional plan view pane (Blocks 1314, 1308). When arranging the selected product (Block 1314), the user may undo or redo operations (Block 1316). Further, when arranging the selected product, any product collisions, such as improper positioning, are detected and/or disallowed (Block 1318). The arrangement of products in the two dimensional pane causes the three dimensional pane to be updated to display the current design layout (Block 1310). Further, updates to the two dimensional pane also update the current product inventory of the design layout (Block 1320) which may be displayed by the user (Block 1322).

A method/system for simultaneously displaying, navigating, selecting and assembling of complex 2D and 3D objects and configurations using a multi-pane graphical user interface has been disclosed. The disclosed embodiments permit complex functions to be performed and complex design layouts to be created using a minimal number of user actions. In one embodiment, the panes of the display are fixed in size and orientation to standardize the interface. In an alternate embodiment, the panes may be individually sized and positioned on the display.

One of ordinary skill in the art will appreciate that the designs of the graphical elements in the exemplary displays are for aesthetic purposes and that other graphical designs may also be suitable. Further, one of ordinary skill in the art will appreciate that there are numerous methods of creating a computer program to implement the disclosed embodiments. It will be further appreciated that, dependent upon the implementation, the logic and functions disclosed herein may be implemented using any number of programming languages and software development tools. It will be appreciated that the disclosed embodiments are defined by the disclosed functionality, rather than the implementation of that functionality.

The disclosed graphical user interface is preferably created using the following programming tools:

Microsoft Visual Studio 6.0: Used to generate, verify and document the computer program source code using the C++ computer programming language. Published by the Microsoft Corporation, located in Redmond, Wash.

Microsoft Foundation Classes (“MFC”): A component of the Microsoft Visual Studio, this software technology is used to implement the user interface. MFC provides functionality such as buttons, views, scrolling views, image display, mouse and keyboard control, dialog boxes, and basic collection classes (lists, maps). In addition, extensions to MFC were added for additional functionality such as buttons loading images via XML and jpg/png image files, dynamic sized and configured window views, auto garbage collected collection classes and flyout icons.

Xerces XML Parser: This software is used to read in XML files and convert them into runtime DOM objects which can be accessed from C++ code. Primarily used to implement the loading of the catalog menu. Published by the Apache Software foundation, www.apache.org.

Open GL: A component of the Microsoft Visual Studio, this graphics library is used to implement three dimensional visualization of products.

Graphical Device Interface (“GDI+”): Windows based software interface for implementing two dimensional drawing to both the display screen and printer. This software is part of the Win32 programming application program interface published by the Microsoft Corporation, located in Redmond, Wash.

The following software tools were used in the development of the user interface and in the data sets used by the user interface:

AutoCAD: This software tool was used for creating and manipulating 3d and 2d drawing files. Published by Autodesk, Inc., located in San Rafael, Calif.

3D Studio Max: This software program was used for further manipulating 3D drawing files and add texturing information. Published by Discreet, located in Montreal, Quebec, Canada.

XML Spy: This software tool was used for creating/editing XML data and particularly for immediately verifying that XML data conforms to defined parameters. Published by Altova, Inc., located in Beverly, Mass.

Together J (UML modeling and diagramming): This software was used in the design and implementation of code used in the database. Published by Togethersoft Corp., located in Raleigh, N.C.

While the ZTNG programming code is written in C++, the data files containing the catalog and other data is in the form of Extensible Markup Language (“XML”) or packed binary data.

Software programming techniques were also employed from the following sources, herein incorporated by reference:

www.codeguru.com;

MFC Internals: Inside the Microsoft(c) Foundation Class Architecture by George Shepherd, Scott Wingo, Dean D. McCrory (1^{st} Edition, 1996).

Programming Windows, The Definitive Guide to the Win32 API by Charles Petzold (5^{th} Edition, 1998).

Design Patterns by Erich Gamma, Richard Helm, Ralph Johnson, John Vlissides (1^{st} Edition, 1995).

Effective C++: 50 Specific Ways to Improve Your Programs and Design (2nd Edition) by Scott Meyers (2^{nd} Edition, 1997).

It is therefore intended that the foregoing detailed description be regarded as illustrative rather than limiting, and that it be understood that it is the following claims, including all equivalents, that are intended to define the spirit and scope of this invention.

We claim:

1. A method for interfacing a user with a product specification computer program used for generating a design, said design comprising a configuration of a plurality of products, said method comprising:
(a) displaying a window on a computer display coupled with a computer comprising said computer program, said window operable to render at least first, second, third and fourth portions, each of said first, second, third and fourth portions capable of receiving input from a user via a user input device coupled with said computer and displaying output to said user;
(b) displaying in said first portion, at least one portion of a catalog of said plurality of products available for inclusion in said design;
(c) receiving in said first portion, a selection by said user of a first product from said catalog for inclusion in said design;
(d) receiving in said first portion, a first configuration of said selected first product;
(e) displaying in said second portion, information specific to said selected first product having said first configuration;
(f) receiving in said third portion, an arrangement specified by said user of said selected first product within said design, said selected first product having said first configuration, wherein said arrangement comprises an assembly of said first product with a second product, said second product having been previously arranged;
(g) displaying in said third portion, a two dimensional plan view of said design comprising said selected, configured and arranged first product; and
(h) displaying in said fourth portion, a three dimensional view of said design comprising said selected, configured, and arranged product.

2. The method of claim 1, wherein said plurality of products comprise a plurality of furniture products.

3. The method of claim 1, wherein said first configuration comprises at least one of size, color and fabric type.

4. The method of claim 1, further comprising:
(i) altering display of said second third and fourth portions to at least one of zoom, rotate and pan said display.

5. The method of claim 4, wherein (i) further comprises allowing said user to specify a focal point of said zoom, rotate and pan.

6. The method of claim 1, wherein (f) further comprises allowing said user to undo said arrangement with a single action.

7. The method of claim 1, wherein said arrangement comprises at least one of orientation and location within said design.

8. The method of claim 7, wherein (f) further comprises automatically selecting a second configuration different from said first configuration based on said arrangement.

9. The method of claim 8, wherein said first configuration comprises a first size of said first product, said second configuration comprising a second size of said first product different from said first size.

10. The method of claim 1, further comprising:
(i) displaying in said third and fourth portions, said first and second products being connected.

11. The method of claim 10, further comprising:
(j) selecting, automatically, any additional products from said catalog necessary to connect said first product with said second product.

12. The method of claim 1, wherein (f) further comprises detecting improper arrangement of said selected first product in relation to said second product previously arranged within said design and further wherein (g) further comprises displaying an indication of said detected improper arrangement.

13. The method of claim 1, wherein (f) further comprises constraining said arrangement substantially within predefined increments.

14. The method of claim 1, further comprising:
(i) adding a description of said selected, configured and arranged first product to an inventory list.

15. The method of claim 1, wherein (b) further comprises displaying a first plurality of selectable items, receiving a first selection of one of said selectable items, and in response to said first selection, displaying an indicator of said first selection, and displaying a second plurality of selectable items associated with said first selection.

16. The method of claim 15, wherein (b) further comprises receiving a second selection of said indicator, and in response to said second selection, re-displaying said first plurality of selectable items.

17. The method of claim 1, wherein (h) further comprises displaying information related to said design.

18. The method of claim 17, wherein said information comprises at least one of overall manufacturing lead time and total cost.

19. The method of claim 1, wherein (h) further comprises updating said three dimensional view in response to (f).

20. The method of claim 1, wherein (e) further comprises displaying a three dimensional view of said selected and configured first product.

21. The method of claim 1, wherein (e) further comprises displaying at least one of manufacturing lead time and cost of said selected and configured first product.

22. The method of claim 21, wherein (e) further comprises dynamically updating said display in response to at least one of (c) and (d).

23. The method of claim 1, further comprising:
(i) receiving in said third portion selection of a previously configured and arranged product; and
(j) displaying in said second portion, information specific to said previously configured and arranged product.

24. The method of claim 1, wherein (e) further comprises providing additional information related to said selected first product.

25. The method of claim 1, further comprising:
(i) facilitating manipulation of said arrangement, in said second portion, of said first selected and configured product in relation to said second product to which said first selected and configured product is coupled.

26. The method of claim 25, wherein (i) further comprises facilitating manipulation of a mounting position of said first selected and configured product on said second product.

27. The method of claim 25, wherein (i) further comprises detecting improper arrangement of said first selected and configured product in relation to said second product and displaying an indication of said detected improper arrangement.

28. The method of claim 1, further comprising:
(i) facilitating specification of said first configuration, in said second portion, of said first selected product, said first configuration being limited only by a capability to manufacture said first selected product according to said specification and not constrained by availability in said catalog.

29. A graphical user interface for interfacing a user with a product specification computer program used for generating a design comprising a configuration of a plurality of products, said graphical user interface comprising:
means for displaying a window means on a computer display coupled with a computer comprising said computer program, said window means operable to render first, second, third and fourth portions, each of said first, second, third and fourth portions capable of receiving input from a user via user input means coupled with said computer and displaying output to said user;
means for displaying in said first portion, catalog means comprising said plurality of products available for inclusion in said design;
means for receiving in said first portion, a selection by said user of a first product from said catalog means for inclusion in said design;
means for receiving in said first portion, a first configuration of said selected first product;
means for displaying in said second portion, information specific to said selected first product having said first configuration;
means for receiving in said third portion, an arrangement specified by said user of said selected first product within said design, said selected first product having said first configuration, said arrangement comprising an assembly of said first product with a second product, said second product having been previously arranged;
means for displaying in said third portion a two dimensional plan view of said design comprising said selected, configured and arranged first product;
means for displaying is said fourth portion a three dimensional view of said design comprising said selected, configured, and arranged product.

30. A graphical user interface for interfacing a user with a product specification computer program used for generating a design comprising a configuration of a plurality of products, said graphical user interface comprising:
a graphical window for display on a computer display coupled with a computer comprising said computer program, said graphical window operable to render first, second, third and fourth portions, each of said first, second, third and fourth portions capable of receiving input from a user via a user input device coupled with said computer and displaying output to said user; and wherein
said first portion comprises a display of at least one portion of a catalog of said plurality of products available for inclusion in said design, said first portion operative to receive a selection by said user of a first product from said catalog for inclusion in said design and further operative to receive a first configuration of said selected first product;
said second portion comprises a display of information specific to said selected first product having said first configuration;
said third portion being operative to receive an arrangement specified by said user of said selected first product within said design, said selected first product having said first configuration, wherein said arrangement comprises an assembly of said first product with a second product, said second product having been previously arranged, and further wherein said third portion comprises a display of a two dimensional plan view of said design comprising said selected, configured and arranged first product; and
said fourth portion comprises a display of a three dimensional view of said design comprising said selected, configured, and arranged product.

31. The graphical user interface of claim 30, wherein said plurality of products comprises a plurality of furniture products.

32. The graphical user interface of claim 30, wherein said first configuration comprises at least one of size, color and fabric type.

33. The graphical user interface of claim 30, wherein said second, third and fourth portions are further operative to allow said user to at least one of zoom, rotate and pan said display.

34. The graphical user interface of claim 33, wherein said second, third and fourth portions are further operative to allow said user to specify a focal point of said zoom, rotate and pan.

35. The graphical user interface of claim 30, wherein said second portion is further operative to allow said user to undo said arrangement with a single action.

36. The graphical user interface of claim 30, wherein said arrangement comprises at least one of orientation and location within said design.

37. The graphical user interface of claim 36, wherein said computer program is further operative to automatically select a second configuration different from said first configuration based on said arrangement.

38. The graphical user interface of claim 37, wherein said first configuration comprises a first size of said first product, said second configuration comprising a second size of said first product different from said first size.

39. The graphical user interface of claim 30, wherein said third and fourth portions are further operative to display said first and second products being connected.

40. The graphical user interface of claim 39, wherein said computer program is further operative to select, automatically, any additional products from said catalog necessary to connect said first product with said second product.

41. The graphical user interface of claim 30, wherein said computer program is further operative to detect improper arrangement of said selected first product in relation to said second product previously arranged within said design, said improper arrangement being indicated in said third portion.

42. The graphical user interface of claim 30, wherein said third portion is further operative to constrain said arrangement substantially within predefined increments.

43. The graphical user interface of claim 30, further comprising an inventory manager coupled with said graphical window and operative to add a description of said selected, configured and arranged first product to an inventory list.

44. The graphical user interface of claim 30, wherein said first portion is further operative to display a first plurality of selectable items and receive a first selection of one of said selectable items, said first portion being further operative to, in response to said first selection, display an indicator of said first selection, and display a second plurality of selectable items associated with said first selection.

45. The graphical user interface of claim 44, wherein said first portion is further operative to receive a second selection of said indicator, and in response to said second selection, re-display said first plurality of selectable items.

46. The graphical user interface of claim 30, wherein said fourth portion further comprises a display of information related to said design.

47. The graphical user interface of claim 46, wherein said information comprises at least one of overall manufacturing lead time and total cost.

48. The graphical user interface of claim 30, wherein said fourth portion is further operative to update said three dimensional view in response to said receipt of said arrangement.

49. The graphical user interface of claim 30, wherein said second portion further comprises a display of a three dimensional view of said selected and configured first product.

50. The graphical user interface of claim 30, wherein said second portion further comprises a display of at least one of manufacturing lead time and cost of said selected and configured first product.

51. The graphical user interface of claim 50, wherein said second portion is further operative to dynamically update said display in response to at least one of said selection and said first configuration.

52. The graphical user interface of claim 30, wherein said third portion is further operative to receive selection of a previously configured and arranged product; and said second portion is further operative to display information specific to said previously configured and arranged product.

53. The graphical user interface of claim 30, wherein said second portion is further operative to provide additional information related to said selected first product.

54. The graphical user interface of claim 30, wherein said second portion is further operative to facilitate manipulation of said arrangement of said first selected and configured product in relation to said second product to which said first selected and configured product is connected.

55. The graphical user interface of claim 54, wherein said second portion facilitates manipulation of a mounting position of said first selected and configured product on said second product.

56. The graphical user interface of claim 54, wherein said second portion detects improper arrangement of said first selected and configured product in relation to said second product.

57. The graphical user interface of claim 30, wherein said second portion is further operative to facilitate specification of said first configuration of said first selected product, said first configuration being limited only by a capability to manufacture said first selected product according to said specification and not constrained by availability in said catalog.

58. A method for interfacing a user with a product specification computer program used for generating a design, said design comprising a configuration of a plurality of products, said method comprising:
(a) displaying a window on a computer display coupled with a computer comprising said computer program, said window operable to render at least first and second portions, each of said first and second portions capable of receiving input from a user via a user input device coupled with said computer and displaying output to said user;
(b) displaying in said first portion, a three dimensional view of said design;
(c) receiving in said second portion, an arrangement specified by said user of a first product selected from a catalog of said plurality of products available for inclusion in said design, wherein said arrangement comprises an assembly of said first product with a second product, said second product having been previously arranged; and
(d) updating said three dimensional view in said first portion to reflect said design having said product in said arrangement.

59. The method of claim 58, further comprising:
(e) displaying in said second portion, said catalog of said plurality of products available for inclusion in said design; and
(d) receiving in said first portion, a first configuration of said selected first product;

60. The method of claim 59, further comprising:
(f) displaying in a third portion, information specific to said selected first product having said first configuration;

61. The method of claim 58, further comprising:
(g) displaying in said second portion, a two dimensional plan view of said design comprising said selected and arranged first product.
